(19) United States
(12) Patent Application Publication
(10) Pub. No.: US 2009/0085262 A1
(43) Pub. Date: Apr. 2, 2009

(54) METHOD FOR MANUFACTURING A COMPOSITE MATERIAL

(76) Inventor: Min-Hsiu Su Hsiao, Taichung (TW)

Correspondence Address: PAI PATENT & TRADEMARK LAW FIRM, 1001 FOURTH AVENUE, SUITE 3200, SEATTLE, WA, 98154, US

(21) Appl. No.: 11/862,898

(22) Filed: Sep. 27, 2007

(51) Int. Cl. B29C 47/00

(52) U.S. Cl. 264/638

(57) ABSTRACT

A method for manufacturing a composite material is disclosed, and the method includes providing a core object, submerging the core object in the thermosetting resin to form the composite material, heating up and solidifying the thermosetting resin, and extruding to form a shape by extrusion molding.

### BACKGROUND

1. Field of Invention

The present invention relates to a composite material, and more particularly to a method for manufacturing a composite material.

2. Description of Related Art

To protect the natural environment globally, developing materials to save power, reduce waste and prevent environmental damage has become very important and has greatly influenced the research direction of polymer production and materials.

Take the architecture industry for example, the building material, decoration material, furniture material are mostly wood. As awareness of environmental protection grows, manufacturers aim at developing wood substitutes to protect forests and jungles and thereby protect the earth's ecology.

Wood-plastic composites (WPC) that have wood-like appearance, greater hardness than plastic material and recycle benefits have been developed and are widely used in the construction and interior decorating industry. However, WPC quality depends on manufacturing processes, and inappropriate proportion distribution of the ingredients affects the mechanical performance of the product. In addition, there are other substitutes constructed by foam and multiple flexible bars (ex. plastic bars) wherein the flexible bars are extruded into the foam. This kind of substitute has better hardness than the foam itself because of the flexible bar design, but nails are difficult to fasten on the substitute because of the foam elasticity such that the substitute is too loose to attach on a surface (wall surface etc.).

As a result, developing another composite material that can be applied in many fields (such as building material, decoration material, furniture material etc.), that can replace wood, conform to environmental protection demands, reduce cost and improve hardness and stiffness is the aim of the present invention.

### SUMMARY

It is therefore an aspect to provide a method for manufacturing a composite material whereby the composite material thereof can be applied to building material, decoration material and furniture material to decrease weight, conform to environmental protection standards and reduce material cost.

It is therefore another aspect to provide a method for manufacturing a composite material to enhance the strength and stiffness of the material through the core object design, and shorten the manufacturing period through the thermosetting resin which is capable of being manufactured easily.

In accordance with an embodiment of the present invention, the method for manufacturing a composite material includes providing a core object, submerging the core object in the thermosetting resin, heating up and solidifying, and extruding and forming the composite material with an extruder.

The method for manufacturing a composite material further includes forming a skin by coating a film, spreading a lacquer or attaching a grained surface to provide decoration and protection effects.

As a result, the method for manufacturing a composite material of the present invention has the following effects:

Applying the composite material to various fields (such as building material, decoration material, furniture material etc.) to replace conventional wood can decrease weight, conform to environmental protection standards and reduce the material cost. In addition, the core object design raises the strength and stiffness, and the thermosetting resin is capable of being manufactured and fabricated easily such that the manufacturing period is shortened and the fastening effect is also improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic manufacturing process of an embodiment in accordance with the present invention;

FIG. 2 is a flow chart of the embodiment in accordance with the present invention;

FIG. 3 is a sectional view of the composite material of the embodiment in accordance with the present invention; and

FIG. 4 is a sectional view of the composite material of another embodiment in accordance with the present invention;

FIG. 5 is a sectional view of the composite material of another embodiment in accordance with the present invention; and

FIG. 6 is a sectional view of the composite material of another embodiment in accordance with the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

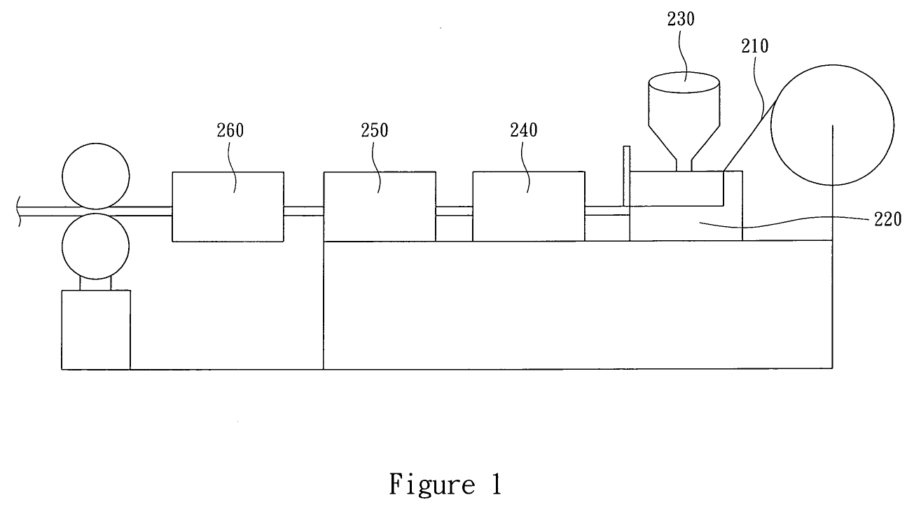

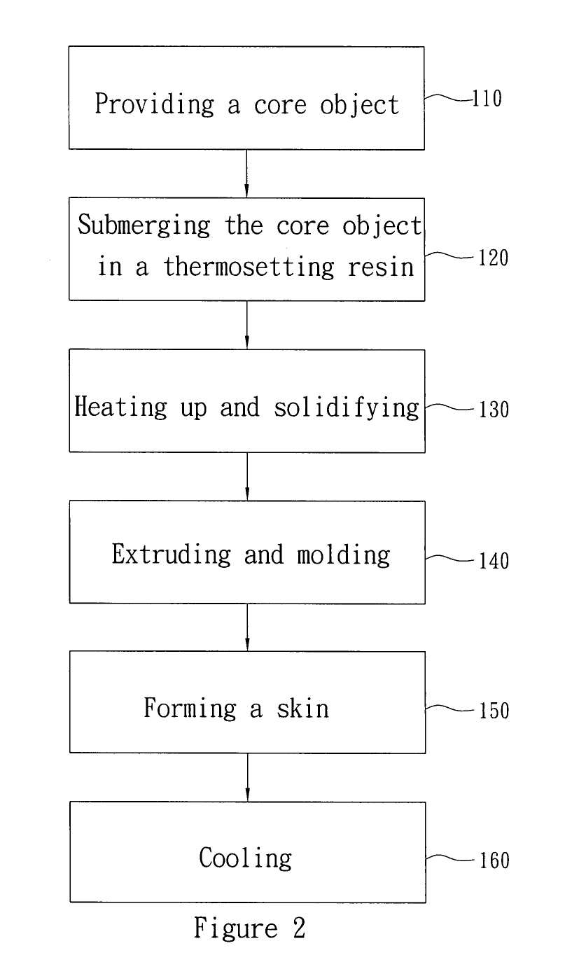

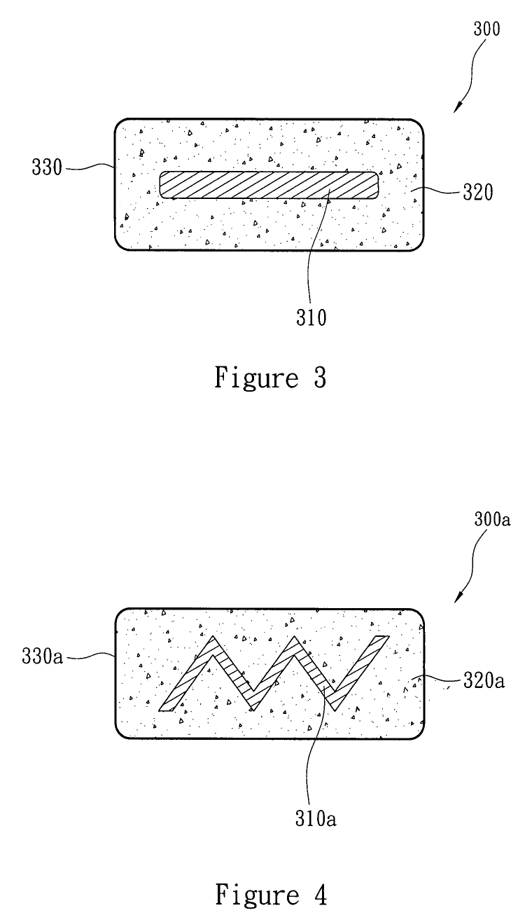

Refer to FIG. 1, FIG. 2 and FIG. 3. FIG. 1 illustrates a schematic manufacturing process of an embodiment in accordance with the present invention; FIG. 2 illustrates a flow chart of the embodiment in accordance with the present invention; FIG. 3 illustrates a sectional view of the composite material of the embodiment in accordance with the present invention.

In step 110, a core object 310 is provided wherein the core object 310 may be but not limited to cardboard, non-woven fabric, polyester fiber, polyamide fiber, fiber glass, carbon fiber, plastic film or the fabric made of any of the above fibers or the combination thereof.

In step 120, conveying the core object 310 to a tank 220 through feeding wheels 210 wherein the tank 220 includes a sprue 230 whereby the thermosetting resin 320 is supplied to fill up the tank 220. The core object 310 is submerged in the thermosetting resin 320 to form a compound. In this embodiment, the thermosetting resin 320 may be but not limited to unsaturated polyester, phenol resin, epoxy resin, silicon resin or urethane resin.

In step 130, the compound is cured by the heating area 240 to solidify the compound to form a precursor material. The heating temperature in the heating area 240 is approximately between 60° C. and 150° C., but the practical heating temperature depends on various conditions, such as the heat endurance of the core object, process design, hardening agent and so on. In other words, the heating temperature is predetermined at a lower temperature when the heat endurance of the core object 310 is inferior wherein the predetermined temperature is between the heating temperature enabling the thermosetting resin 320 to generate chemical reaction and the limit temperature which is endurable for the core object 310. Regarding process design, raising the heating temperature shortens the hardening period of the thermosetting resin 320, and lowering the heating temperature extends the hardening period of the thermosetting resin 320. Through this step, the thermosetting resin 320 is gradually solidified to shape a formation by heating. In this embodiment, the thermosetting resin is disclosed for illustration only, other resins having irreversible rigid and melt properties on being heated constantly can also replace the material strengthening the core object 310.

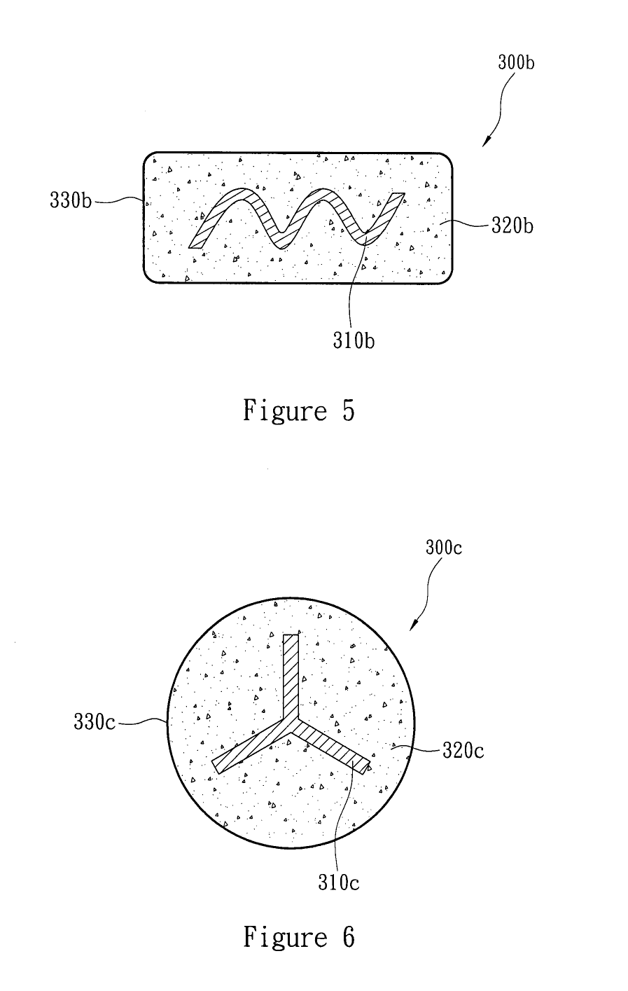

In step 140, the solidified precursor material (the compound of the core object 310 and the cured thermosetting resin 320) is extruded through a die of the extruder 250 to form a composite material 300. Therefore, the final appearance of the product is variable because of different die in accordance with the customer requirement. In the embodiment of FIG. 3, the core object 310 is a sheet object, and the thermosetting resin 320 has a rectangular section by a rectangular die. The core object 310 of the composite material 300 is used to enhance the strength and stiffness thereof, so other core objects with various formations can also be used to provide the same strength and stiffness effects. Refer to other composite material embodiment in FIG. 4 and FIG. 5, the core object 310a has a saw-tooth formation, and the core object 310b has a wavy formation.

In addition, the thickness of the core object is altered in accordance with composite material size, and the smaller core object makes the composite material harder. In general, the core object has the same weight proportion as the thermosetting resin. In this embodiment, the distribution in proportion between the core object and the thermosetting resin is approximately 1:9. The practical distribution in proportion should be designed in accordance with various conditions (size, material, weight proportion, hardness etc.) of the product, and the above distribution in this embodiment is disclosed for illustration only.

Refer to FIG. 6. FIG. 6 illustrates a sectional view of the composite material of another embodiment in accordance with the present invention. In this embodiment, the thermosetting resin 320c is extruded by a circular die, and the core object 310c includes three ribs outward scattered alternately from the center of the composite material 300c.

In step 150, forming a skin 330 on the composite material 300 to provide decoration and protection effects after the formation of the product is determined. This step includes coating a film through thermal melt-joint method, spreading a lacquer, or attaching a grained surface for ornamental purposes. In addition, other skin forming methods such as wrapping a metal slice (iron slice or aluminum slice) can be used to enhance the strength when the product application field has impact endurance requirement. In this embodiment, the skin 330 is a thermoplastic film with a thickness between 0.5 and 3 mm.

In step 160, cooling the composite material 300 with the skin 330 through the cooling area 260 to firm the skin 330 to provide the final product of the embodiment.

As embodied and broadly described herein, applying the composite material 300 to various field (such as building material, decoration material, furniture material etc.) to replace conventional wood can decrease weight, conform to environmental protection standards and reduce the material cost. In addition, the core object 310 design raises the strength and stiffness, and the thermosetting resin 320 is capable of being manufactured and fabricated easily such that the manufacturing period is shortened and the fastening effect is also improved.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for manufacturing a composite material, comprising:
(A) providing a core object;
(B) submerging the core object in a thermosetting resin to form a compound;
(C) heating up and solidifying the compound to form a precursor material; and
(D) forming the composite material by extruding and molding the precursor material with an extruder and a die wherein the die defines a shape of the composite material.

2. The method of claim 1, further comprising (E) forming a skin on the composite material.

3. The method of claim 2, wherein the step (E) is performed by coating a film.

4. The method of claim 3, wherein the film is a thermoplastic film with a thickness between 0.5 and 3 millimeters.

5. The method of claim 2, wherein the step (E) is performed by spreading a lacquer.

6. The method of claim 2, wherein the step (E) is performed by attaching a grained surface.

7. The method of claim 2, wherein the step (E) is performed by wrapping a metal slice.

8. The method of claim 7, wherein the metal slice is iron slice or aluminum slice.

9. The method of claim 2, further comprising (F) cooling the composite material with the skin.

10. The method of claim 1, wherein the core object is a sheet object.

11. The method of claim 10, wherein the core object has a saw-tooth section.

12. The method of claim 10, wherein the core object has a wavy section.

13. The method of claim 1, wherein the core object comprises multiple ribs outward scattered alternately from a center of the composite material.

14. The method of claim 13, wherein the ribs comprise three ribs.

15. The method of claim 1, wherein the core object is a cardboard, a non-woven fabric, a polyester fiber, a polyamide fiber, a fiber glass material, a carbon fiber, a plastic film or a fabric made of any of the above fibers or the combination thereof.

16. The method of claim 1, wherein the thermosetting resin is an unsaturated polyester, a phenol resin, an epoxy resin, a silicon resin or an urethane resin.

17. The method of claim 1, wherein a distribution in proportion between the core object and the thermosetting resin is approximately 1:9.

18. The method of claim 1, wherein the heating temperature in step (C) is approximately between 60° C. and 150° C.

19. The method of claim 1, wherein the die is a rectangular die.

20. The method of claim 13, wherein the die is a circular die.
